(19) United States
(12) Patent Application Publication
(10) Pub. No.: US 2016/0063416 A1
(43) Pub. Date: Mar. 3, 2016

(54) WEB-BASED, ELECTRONIC SYSTEM AND METHOD FOR PROVIDING BUSINESS AUTOMATION INFORMATION EXCHANGE SERVICES

(71) Applicant: Rajesh Sharma, Milford, CT (US)

(72) Inventor: Rajesh Sharma, Milford, CT (US)

(21) Appl. No.: 14/835,910

(22) Filed: Aug. 26, 2015

Related U.S. Application Data
(60) Provisional application No. 62/042,984, filed on Aug. 28, 2014.

(51) Int. Cl. G06Q 10/06; G06F 17/22; G06F 17/24; H04L 29/08

(52) U.S. Cl. CPC G06Q 10/06313; H04L 67/02; G06F 17/2247; G06F 17/248; G06F 17/243

(57) ABSTRACT

A business application is more easily and efficiently built utilizing a series of tools designed to facilitate information exchange between a publisher and a subscriber. Without the need for software programming, users are able to build e-commerce and other publication applications to organize and produce information for receipt by other users using modular components while maintaining the functionality expected from such applications. The information exchange can be implemented both through a web browser and an application programming interface.

### CROSS-REFERENCE TO RELATED APPLICATIONS

This application claims the benefit of priority to U.S. Provisional Patent Application No. 62/042,984, filed Aug. 28, 2014, the entire disclosure of which is hereby incorporated by reference herein.

This patent disclosure contains material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

All patents, patent applications and publications cited herein are hereby incorporated by reference in their entirety. The disclosures of these publications in their entireties are hereby incorporated by reference into this application in order to more fully describe the state of the art as known to those skilled therein as of the date of the invention described herein.

### BACKGROUND OF THE DISCLOSURE

Internet users perform a number of activities on the Internet such as web browsing (searching for information), placing online orders, making schedules, posting their opinions and reviews, transferring files to other users, etc. All these activities are performed on websites, web-based applications, emails, file transfer protocol (FTP), chat, etc. Businesses automate business processes and online services, offered to customers, by developing their own custom websites and web applications. Not only it is hard for the users to find required authentic information in a vast number of websites, it requires custom software development for the businesses to develop, host and maintain these websites and applications. Users on the Internet also face a number of other challenges such as establishing authenticity of content, blocking unwanted information delivered via spam, finding intended audiences to publish information, etc.

There are a number of websites/web-based services on the Internet that let the users build and host websites using pre-defined HTML (hypertext markup language) templates. However, the websites built on such platforms are either limited to have only static HTML content with no business functionality or have pre-built functionality such as shopping cart, user feedback etc. that cannot be customized and no new custom functionality can be added.

The websites on the Internet work independently of each other with no single unified system on the Internet that can be used to centrally exchange information between applications. Often the businesses require integration of different business applications hosted by same or different businesses to exchange data between them, which in turn requires more custom programming to build integration systems. Also, business logic implementation is repeated on various websites that are built for the same business domain since the business rules are same or similar. For example, most restaurant websites implement online ordering using the same logic since business rules for online ordering for most restaurants are similar, only the data and the user interfaces are different.

After going through the summary of challenges described above, one skilled in the art would appreciate a different way of automating business processes over the Internet, where business processes can be designed and executed by users on a single unified user interface with no software programming required. This way all applications run on single platform eliminating need for programming custom web applications, hosting them on servers and maintaining user registration databases by individual application owners. The users register only once on the platform eliminating the need for them to maintain credentials (user names and passwords) for each web application separately that they use.

### BRIEF SUMMARY OF THE INVENTION

In one aspect, the invention relates to a web-based, electronic system for providing business automation information exchange services including an application design engine for assembling business automation designs from application building blocks, application designs, and website designs, an application execution engine, the application execution engine including an application executor for executing the application designs, an user connection manager for connecting a first user and one or more users, wherein an application designed by the application design engine facilitates at least one publication exchange between the first user and the one or more users upon execution of the business automation designs, wherein the application design engine, application execution engine, and user connection manager are hosted on a web server accessible by the one or more users, and wherein the business automation designs are created without software programming. In some embodiments, the application building blocks are selected from the group consisting of: data templates defining business data formats, data views, data filters, data instances, the publication templates defining the format of the publications to be exchanged, the publications, subscriptions to subscribe to and receive the publications, HTML content, and combinations thereof. In some embodiments, the business automation information exchange services are accessed through an interface selected from the group consisting of: a web browser, an application programming interface, and combinations thereof. In some embodiments, the interface is an application programming interface, and wherein the system further comprises a business automation client. In some embodiments, the application execution engine includes a website host for rendering websites.

In some embodiments, publications are rendered by the application execution engine, wherein the publications are created using a publication template selected from the group consisting of: a web form, text, XML, a file, media album, and combinations thereof. In some embodiments, the publications are selected from the group consisting of: a broadcast publication, an application publication, and a library publication. In some embodiments, the publication is an e-commerce web form. In some embodiments, the data fields are bound to form fields in the publication to facilitate entry of data instances into the publication.

In some embodiments, the present disclosure is directed to a web-based, electronic method for providing business automation information exchange services including the steps of providing an application design engine, providing an application execution engine, providing a user connection manager for managing connections between at least a first user and at least a second user, assembling a business automation design using the application design engine, subscribing the at least a second user to a publication, executing the business automation design using the application execution engine to render a publication and send the publication to the at least a second user, and wherein the business automation design is created without software programming.

In some embodiments, the web-based, electronic method further comprises the step of creating a publication. In some embodiments, the step of creating a publication includes the steps of selecting a publication template including at least one form field, binding a data field to the at least one form field, and uploading a data instance to the data field. In some embodiments, the publication is selected from the group consisting of: a broadcast publication, an application publication, and a library publication.

In some embodiments, the web-based, electronic method further comprises the step of registering the at least a first user and the at least a second user for the at least a first set of roles associated with the business application design.

In some embodiments, the step of assembling a business automation design using the application design engine includes the steps of defining at least a first set of roles for the at least a first and second users, wherein the rendering of the publication and sending of the publication is based on the at least a first set of roles defined for the users.

In some embodiments, the web-based, electronic method further comprises the step of defining access control for the at least a first user and the at least a second user.

In some embodiments, the business automation designs are stored for access by users of the system.

### BRIEF DESCRIPTION OF THE DRAWINGS

The following figures are illustrative only and are not intended to be limiting.

FIG. 1 is a high level diagram of a business automation and information exchange system and services offered by the system to its users.

FIG. 2 is an architecture diagram that provides details of sub systems including hardware and software of the system shown in FIG. 1.

FIG. 3A is a block diagram of application building blocks used by the application design engine shown in FIG. 1 to build application designs and website designs.

FIG. 3B is a diagram that explains data binding functionality used in the system shown in FIG. 1.

FIG. 3C is a block diagram of an application design in the system shown in FIG. 1.

FIG. 4 is a diagram of rendering and execution of an application in the application execution engine shown in FIG. 1.

FIG. 5 depicts several examples of common scenarios automated using publication exchanges and business applications built on the system shown in FIG. 1.

FIG. 6 is diagram of an application design of electronic prescription application, as an exemplary business process automated on the system shown in FIG. 1 using publications and roles.

FIG. 7 is an example of custom business website design on the system shown in FIG. 1.

FIG. 8 is an example of unified user interface displayed a user on the system shown in FIG. 1 for various applications used by the user.

FIG. 9 is a diagram of user connections and their properties created in user connection manager by users of the system shown in FIG. 1.

FIG. 10 is screenshot of an example of publication template built for application design of an online order application for restaurant business in the system shown in FIG. 1.

FIG. 11 is a screenshot that shows an example of expression designer to design expressions for data binding in the system shown in FIG. 1.

FIG. 12 is screenshot of a publication at runtime in an application based on the application design shown in FIG. 10.

FIG. 13 is screenshot of an example of data template in the system shown in FIG. 1 to upload restaurant menu data.

### DETAILED DESCRIPTION OF THE INVENTION

The issued patents, applications, and other publications that are cited herein are hereby incorporated by reference to the same extent as if each was specifically and individually indicated to be incorporated by reference.

The singular forms “a,” “an,” and “the” include plural reference unless the context clearly dictates otherwise.

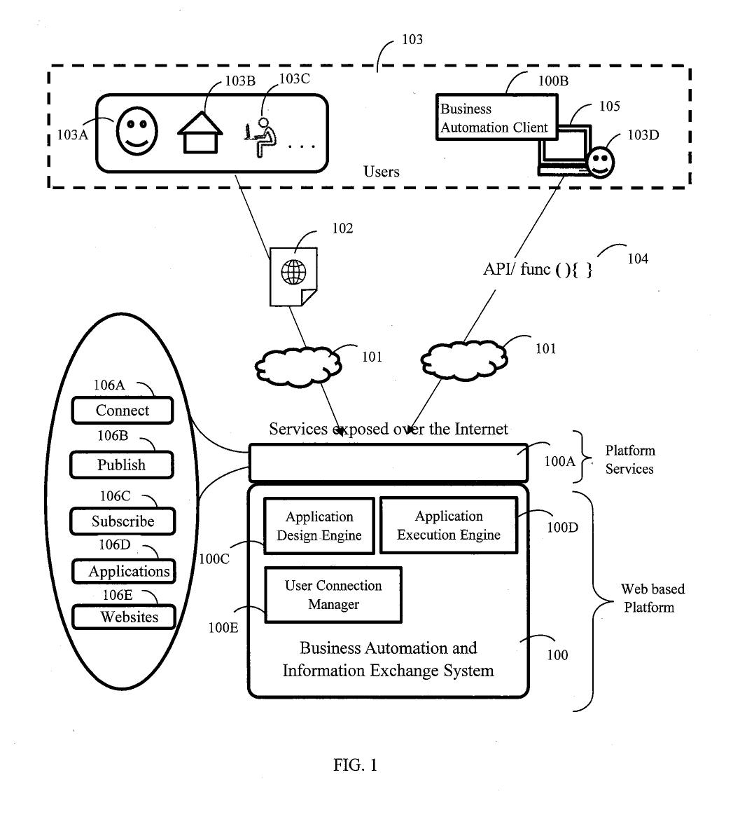

In some embodiments, the invention relates to a web-based, electronic system for providing business automation information exchange services. FIG. 1 is a high level block diagram of a web based platform, labeled as Business Automation and Information Exchange System (hereinafter referred as “system 100”). In some embodiments, system 100 offers services 100A to users 103 on the Internet 101 through two interfaces: (1) a website 102 that can be accessed by users 103 from a web browser and (2) application programming interface (API) 104 for programmatically accessing services 100A from a user's computer 105. In some embodiments, system 100 is accessed through a mobile device, such as a mobile phone, tablet, PDA, laptop, and the like.

In some embodiments, system 100 includes three primary sub-systems: application design engine 100C, application execution engine 100D, and user connection manager 100E. In some embodiments, system 100 also includes a business automation client 100B that runs on user's computer 105 to make calls into system API 104.

In some embodiments, users on system 100 (users 103) use system's website 102 on a standard web browser or make calls into API 104 to access system services 100A. In some embodiments, users 103 are pre-registered to use the system. In some embodiments, users 103 only have access to a subset of system services 100A. In some embodiments, users 103 have access to all system services 100A. Even though all of the system services 100A are available to all of the users 103, certain type of features are more commonly used by certain types of users. In this disclosure, for the purpose of describing various types of features, user 103A represents any regular user, user 103B represents a business user, user 103C represents a subject matter expert in a business domain, and user 103D represents a user who accesses system 100 programmatically from computer 105 using business automation client 100B downloaded to computer 105 to call into application programming interface (API) 104. User 103A is a general user in the system 100 that will be used to describe any user in general from users 103 in this disclosure.

In some embodiments, features offered to a user from users 103 through system services 100A are:
a. Connect (designated as 106A) with plurality of users 103 and manage the connections.
b. Define structured information and offer it as publications to users 103 for subscription. Publish (designated as 106B) information to selected users from users 103 or broadcast it to all subscribers from users 103.
c. Subscribe (designated as 106C) to information publications offered by plurality of users 103.
d. Create business applications 106D to automate business processes using interactive designers with no programming (software development) required.
e. Create fully functional websites 106E with HTML content and business functionalities, no programming required.
f. Run business applications 106D to execute business processes. User 103A can sign up for plurality of applications 106D of user's choice and run them on website 102.
g. Interface with business applications 106D programmatically through system API 104 using business automation client 100B on user's computer 105.

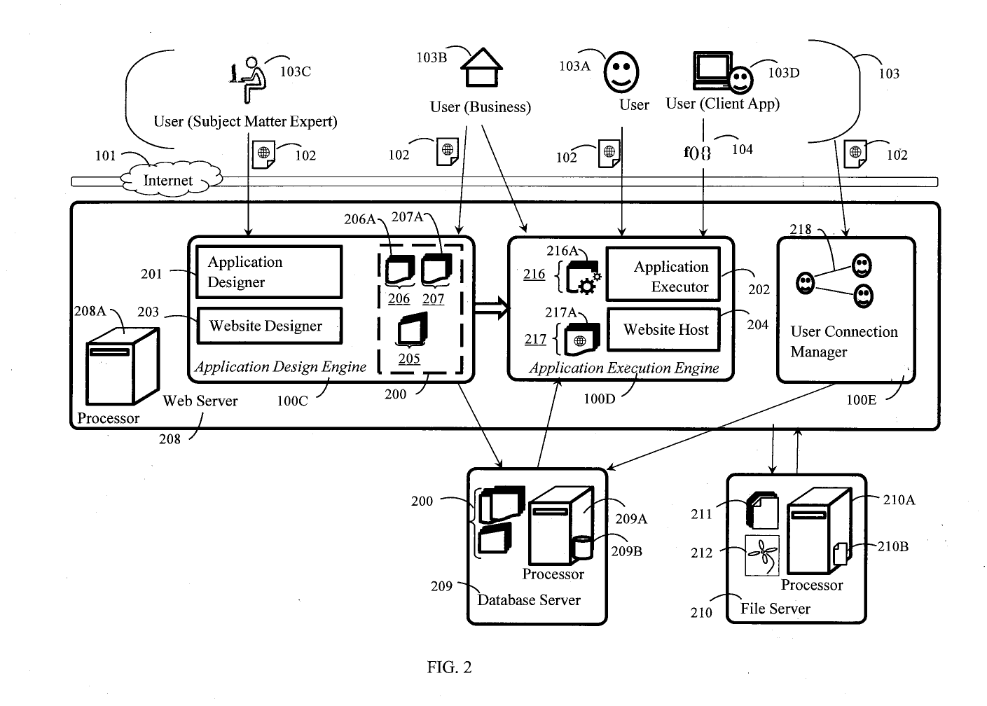

Referring to FIG. 2, in some embodiments, system 100 comprises three primary subsystems: (1) application design engine 100C, (2) application execution engine 100D, and (3) user connection manager 100E. In some embodiments, these subsystems are hosted on web server 208 with processor 208A to expose system services 100A to users 103 on website 102 and application programming interface (API) 104.

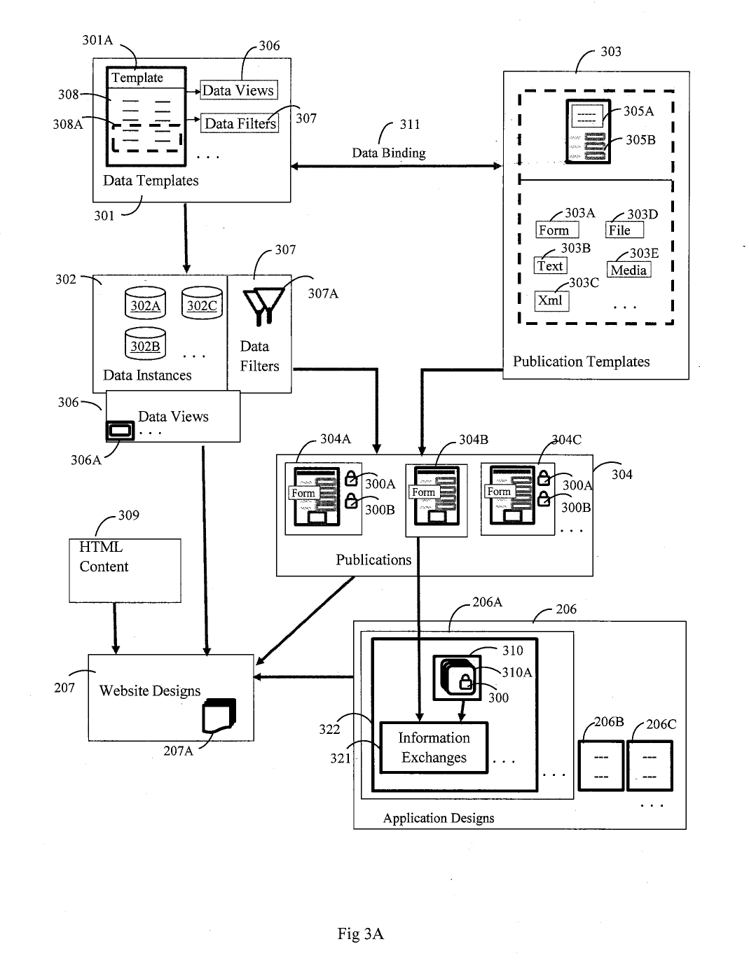

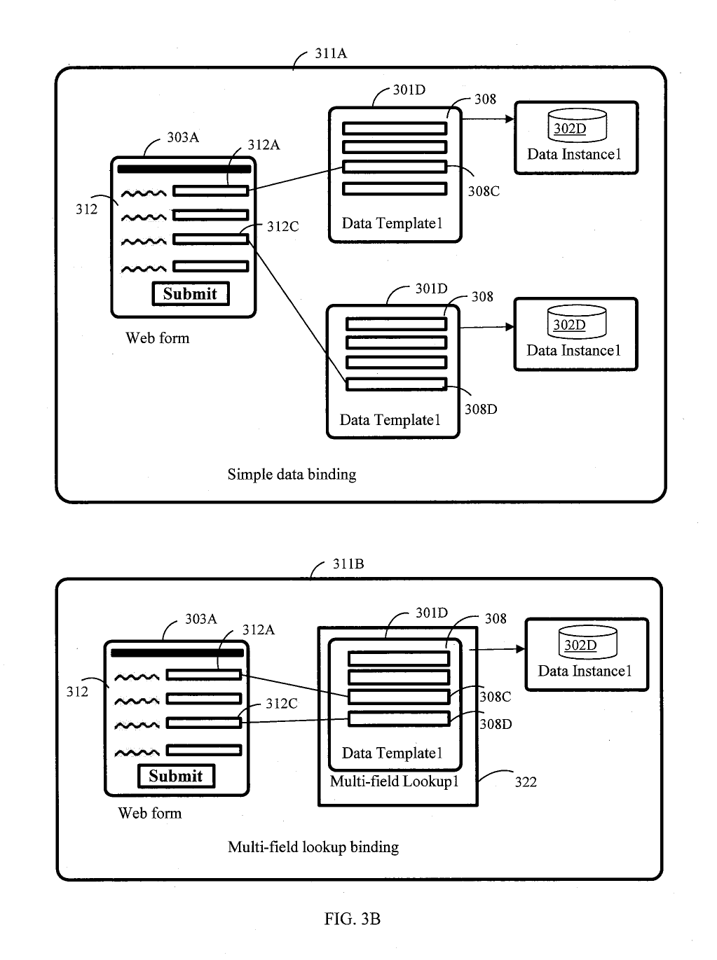

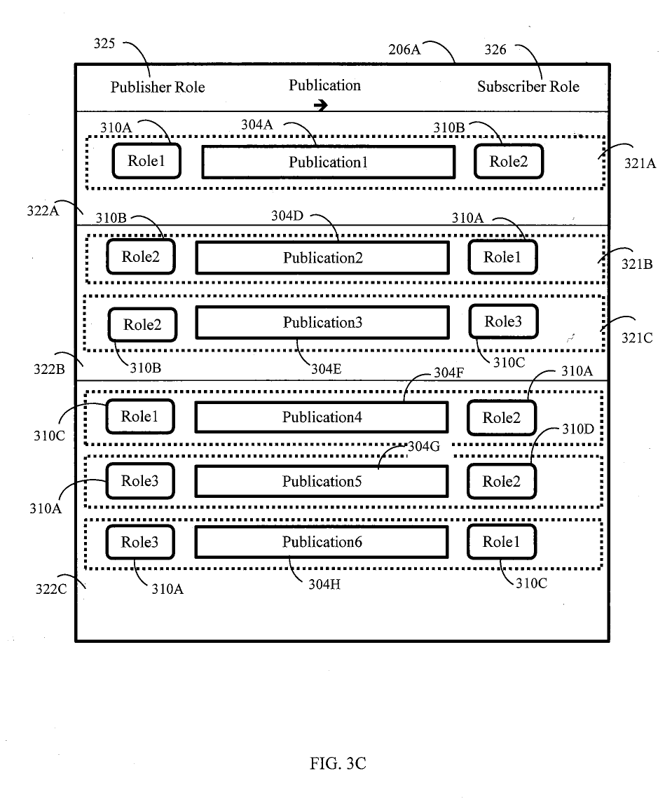

In some embodiments, the first primary subsystem, application design engine 100C, allows users 103 to at least create business automation designs 200 that include application building blocks 205, application designs 206 and website designs 207. In some embodiments, application design engine 100C includes two designers: application designer 201 and website designer 203. User 103C is a user who is a subject matter expert in a business domain. In an exemplary embodiment, user 103C first uses application design engine 100C to create application building blocks 205. Then, user 103C assembles application designs 206 and website designs 207 using application building blocks 205, which are publication templates, publications, data templates etc. as shown in detail in FIG. 3A and described later. In some embodiments, the above-identified application design steps are performed by a user other than user 103C.

In some embodiments, user 103C creates and releases business automation designs 200 for use by other users in the business domain. Some examples of business domains are aviation, healthcare, telecommunications, and the like. In instances where user 103B (a business) is either not able to find desired business automation designs 200 released by a subject matter expert such as user 103C or if user 103B has specific requirements not addressed by business automation designs previously configured by user 103C, user 103B creates its own business automation designs 200. Business automation designs 200 are stored on database server 209 that includes processor 209A and storage disk 209B.

In some embodiments, the second primary subsystem (application execution engine 100D) of system 100 includes at least an application executor 202 and website host 204. Business automation designs 200 are loaded from database server 209 by application execution engine 100D and, in some embodiments, executed as fully functional business applications 216, and business websites 217.

In some embodiments, execution of business automation designs 200 results in a sequence of information exchanges between users 103. An example of application design 206A is the layout and format of a web form designed by user 103B (a business) to receive online orders from customers, such for use in e-commerce. An example of execution of application design 206A as a business application 216A is functional online order web form presented to user 103A to enter and submit online orders to user 103B using this web form. User 103D, who chooses to programmatically execute application 216, calls application execution engine 100D using API 104. Continuing with the earlier online ordering example, user 103D may submit online order programmatically to user 103B through API 104 by making a programming call and supply all the fields needed to place order.

Design and execution of business automation designs 200 may require files 211 and images 212 to be stored and exchanged. In some embodiments, files 211 and images 212 are stored on a file server 210 that includes processor 210A and storage disk 210B.

In some embodiments, the third primary subsystem (user connection manager 100E) allows a user such as user 103A to connect with a plurality of other users 103. In some embodiments, user 103A connects with other users to at least design, share, and run business applications 216 to automate its business processes. Using the connections 218 in business process automation eliminate the need to maintain separate user databases for various business applications 216. In some embodiments, user connection manager 100E also allows user 103A to organize its connections 218 into various groups for better management of connections.

### Application Design Engine:

Consistent with some embodiments of system 100, FIG. 3A depicts the details of various types of the application building blocks 205 and their assembly to build application designs 206 and website designs 207. In some embodiments, application building blocks comprise data templates 301, data instances 302, publication templates 303, publications 304, HTML content 309, and the like.

A data template, such as data template 301A, is an application building block 205 that defines a schema (the data field definitions) of fully de-normalized business data. Fully de-normalized data is data that doesn't reference data fields in other data. As a result, fully de-normalized data has data repetitions, but data storage and data retrieval are simpler than with normalized data. For example, if a product comes in three colors, fully de-normalized data for that product would include three records for this product with all the field values repeated except for the color field. In normalized form, the product data in this example is stored as two sets of data, one data set for products with one record per product that references a second data set containing product colors and product codes.

In some embodiments, building business applications 216 and websites 217 to automate business processes requires data input. In some embodiments, that data comprises custom business data represented by data instance 302A, business domain specific data represented by data instance 302B, generic data represented by data instance 302C, and combinations thereof and the like. For example, an airline may require the following data to automate its business processes: flight schedules, countries, and airports. The “flight schedules” are custom business data designated by data instance 302A, which is different for different airlines and needs to be uploaded by each airline separately. “Airports” is business domain specific data designated by data instance 302B that can be uploaded by one airline, for example user 103B, and used by multiple airlines. “Countries” is generic data designated by data instance 302C that can be uploaded by one user, for example user 103B, and can be used by plurality of users 103, even the users outside the airline industry. User 103B who, as an example, owns “Airports” data and “Countries” data, uploads data to system 100 and can choose to share uploaded data with other users on system 100.

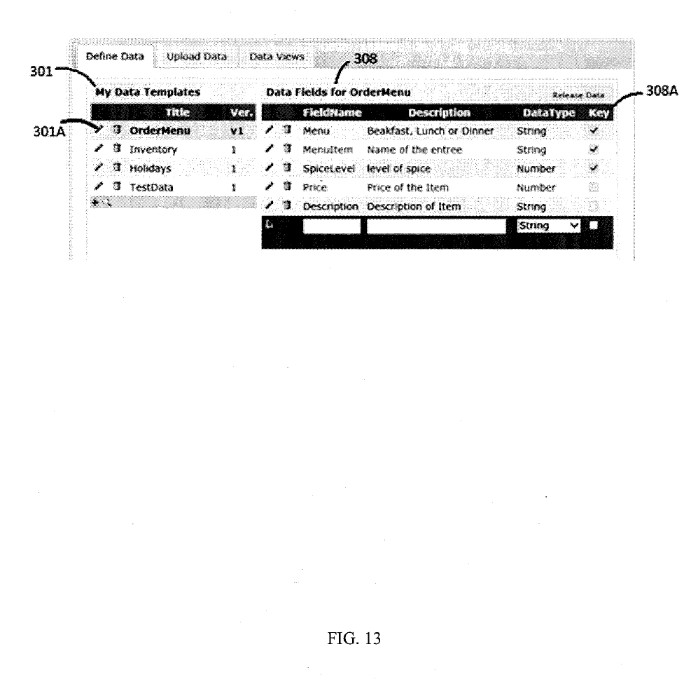

In some embodiments, before data instance 302A is uploaded, a data template such as data template 301A for data instance 302A is created. Data template 301A is created by specifying data fields 308 for data template 301A that define data format of data to be uploaded. In some embodiments, data templates 301 are created by subject matter experts, for example user 103C, and are published for use by plurality of users 103. A screenshot of a data template 301 created by a user 103B (a business, in this example a restaurant) consistent with some embodiments of the present disclosure is shown in FIG. 13. The selected data template 301A named “OrderMenu” is created for online ordering process. Data template 301A (OrderMenu) has following data fields 308—Menu, MenuItem, SpiceLevel, Price and Description. For each data field 308, name of the field, its description and the data type are defined. Data fields that together identify a single data record are marked as key fields 308A. For example, key fields 308A in data template 301A (OrderMenu) are Menu, MenuItem and SpiceLevel since these three fields uniquely identify one item in data instance 302A uploaded for data template 301A “OrderMenu”. While defining data fields 308 for a data template 301A, key fields 308A must be defined if the data template 301A is to be used in multi-field lookup setup described later.

In some embodiments, after data template 301A is created, multiple named data instances 302 can be created for data template 301A by uploading actual data that conforms to data template 301A. User 103B who uploaded data to create data instances 302 can choose to share data instances 302, created by user 103B, with plurality of other users 103.

When re-using data instances 302 in different business processes, there may be a need to use only a subset of the data in data instances 302. This can be achieved by creating data filters 307 on data templates 301.

Each data filter in data filters 307 is an expression created by multiple conditions on data fields 308 included in data template 301A. For example, for data template “product” a data filter “affordable deals” can be created as (product_price<50.0 and product_rating>=4) to show only the products with price less than 50.0 and product rating of 4 or better.

In some embodiments, data instances 302 such as data instance 302A are added to one or more of website designs 207 to display the data, wherein only some data fields from data fields 308 of data instance 302A are needed for display in a pre-defined order. For example, of all the data fields 308 in a data template 301A that represents the schema of a “product”, a user may choose to show only following fields in website design 207A: product picture, product name, and product price, excluding all other fields in “product” records. This is achieved by first creating a data view such as data view 306A on data template 301A and then using data view 306A on data instance 302A added to website design 207A. In some embodiments, those data fields 308 are displayed in a predefined order. In some embodiments, multiple data views 306 are created on one data template 301A by selecting a subset of data fields 308 and defining an order and layout in which the selected fields should be displayed for each data view.

System 100 automates business processes and activities on the Internet by breaking them up into sequences of information exchanges (sending and receiving information). Each information exchange is modelled as a publication such as publication 304A that can be shared with plurality of users 103.

A publication such as publication 304A is used by a user who is an information sender, for example user 103A, to send information to plurality of users 103, the information receivers. Application execution engine 100D renders publication 304A, at runtime, to present a functional web form to user 103A for entering and publishing information to plurality of users 103.

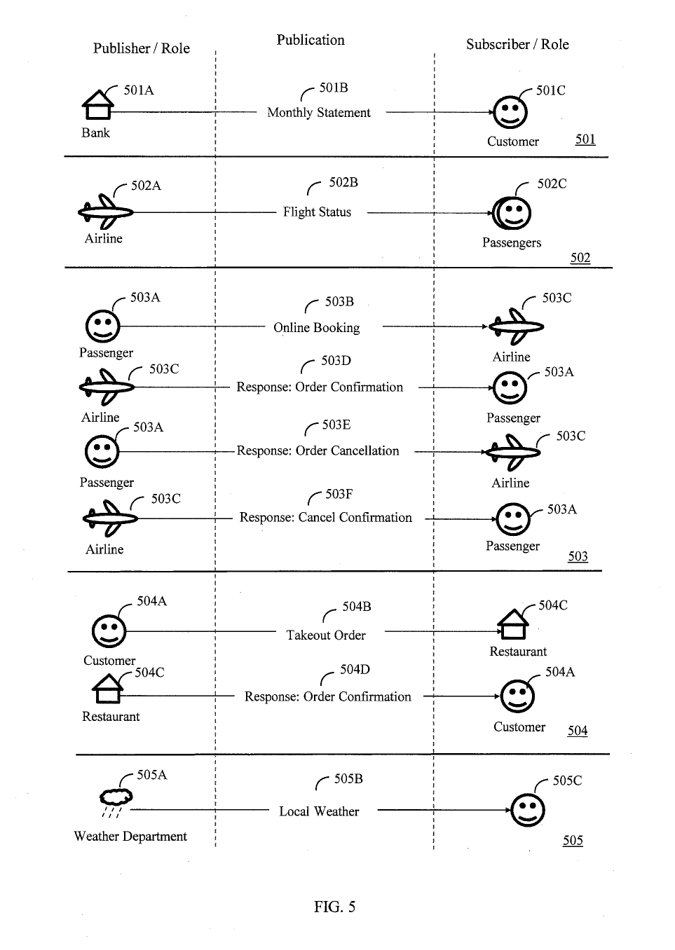

FIG. 5 portrays a publication 504B named “Takeout Order” consistent with some embodiments of the present disclosure. In this embodiment, publication 504B is used in an online order application 504 that allows user 504A, a customer, to place an online order to restaurant 504C. Publication 504B is used by application execution engine to present user 504A, a customer, with an online order form with restaurant's menu data pre-populated in the form. User 504A enters order data in the order form and publishes it by submitting the form, which generates order message for user 504C, the restaurant. User 504C, in response to the received message, publishes order confirmation using publication 504D named “Order Confirmation”.

In some embodiments, a publication such as publication 304A is created using a publication template, such as publication template 303A, that fully defines the information to be exchanged. In some embodiments, a publication template 303 has at least two parts: (1) a message body 305A that defines the format and layout of the information to be exchanged and (2) message properties 305B that define meta-data or the additional context fields that can be used to identify, filter and delivery information to intended recipients.

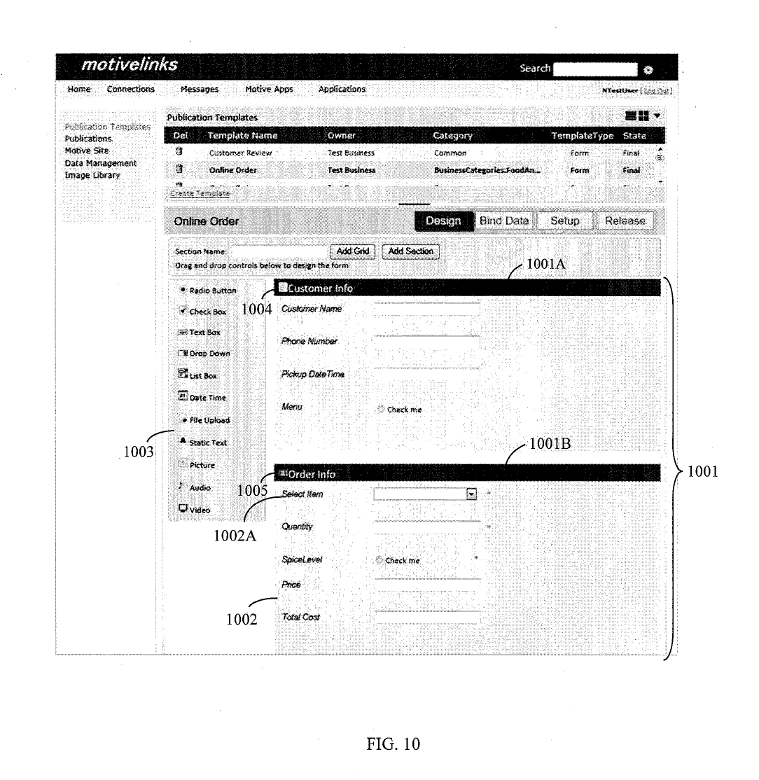

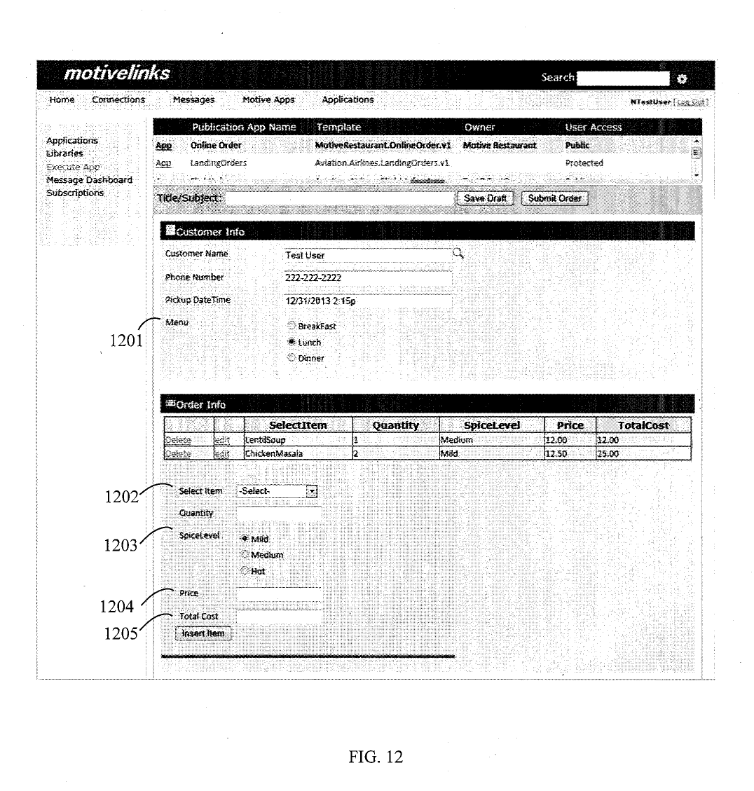

FIG. 10 shows a screenshot of an exemplary publication template 303A, designed for a restaurant's online ordering, as it appears on the system website 102 and is described in detail later. A screenshot of an example of publication 304A created using the publication template 303A (from FIG. 10) is given in FIG. 12 and described later.

In some embodiments, a publication template such as publication template 303A is created for an information type, which specifies the format of message body 305A. Application designer 201 includes several online designer interfaces to design publication templates 303 depending on the type of the information. Commonly used types of publication templates 303 that cover most of the information exchanged on the Internet include, but are not limited to:
a) Web form (Structured Data)—Publication templates 303 of type web form are created when the information to be exchanged can be represented as structured data or hierarchical named elements. For this type of publication template, for example publication template 303A, information publisher such as user 103A uses a web form to enter and publish information. FIG. 10 shows a screenshot of application designer 201 consistent with some embodiments of the present disclosure. The web form 1001 designed in this screenshot is an example of a publication template of type web form such as publication template 303A. In some embodiments, a web form 1001 contains multiple sections, such as section 1001A named “Customer Info” and section 1001B named “Order Info”. Each section contains form fields 1002. In some embodiments, a section can be setup as simple form 1004 or as grid 1005. A section of type grid 1005 allows multiple records of information to be entered when publishing the information. In the web form 1001, the section 1001B named “Order Info” is of type grid 1005, which allows a publisher to enter multiple order info items when publishing information. In some embodiments, web form 1001 is designed by dragging and dropping of controls 1003 that are textbox, drop down list, and the like into various sections of web form 1001 to create form fields 1002 in the sections. In some embodiments, form fields 1002 in the web form are configurable with settings such as the default values, required field flag, etc. set on each field.
b) Text—Referring back to FIG. 3A, in some embodiments, a publication template of type “text” or “formatted text”, for example publication template 303B, is created when the information to be exchanged is text or formatted text such as HTML. The publisher, for example user 103A, is presented with an online text editor or HTML editor to enter the text or formatted text for the message body 305A at runtime. In some embodiments, message properties 305B, if defined in publication template 303B at design time, are also presented to the publisher such as user 103A in a web form at run time while publishing information.
c) XML—In some embodiments, to design publication template 303C, a publication template of type “XML”, application designer 201 provides users 103 with an interface to define xml schema of the xml to be published. Application designer 201 also provides interface to define message properties 305B of the publication template 303C. In some embodiments, at runtime, a publisher such as user 103A can either enter xml in an online xml editor or upload an xml file that conforms to the xml schema defined in the publication template 303C.
d) File—In some embodiments, publication template 303D, a publication template of type “file”, is created for publications 304 that allow exchange of files between users 103. For publication template 303D, message body 305A is the file itself and message properties 305B can either be extracted from the file name or the file data. In some embodiments, a web form is presented to the publisher, for example user 103A, to populate message properties 305B at the time of publishing a file.
e) Media Album—In some embodiments, publication template 303E, which is a publication template of type “media album”, is created to publish video, audio or picture albums. In these embodiments, application designer 201 provides an album designer and an interface to define the message properties 305B for publication template 330E.

In addition to the commonly used types on the Internet described above, designers for other types of information can be created.

An important aspect of designing publication templates 303 is data binding 311. As shown in FIG. 3B, publication templates 303 define the format of the information to be published. One such format type is web form represented by publication template 303A. In some embodiments comprising web forms, some of the form fields provide the users with options to select values from a list of valid values through various multiple choice controls such as dropdown list, radio button list, check boxes, and the like. At runtime, such form fields are pre-populated with possible valid values to provide options to the publisher (such as user 103B). For example, as shown in FIG. 10, form field 1002A is a dropdown list to select a menu item from a restaurant's menu. Form field 1002A is pre-populated with items from restaurant's takeout menu when the web form 1001 is presented to a user for placing an order. This is achieved using data binding 311 setup by mapping a form field 1002A in publication template such as publication template 303A to data field 308A named “MenuItem” in the data template 301A.

Again referring to FIG. 3B, in some embodiments there are two types of data binding 311: simple data binding 311A and multi-field lookup binding 31 lB. In some embodiments incorporating simple data binding 311A, a form field such as form field 312A is bound to a data field 308C. In some embodiments, another form field 312C can be bound independently of the data binding in form field 312A to same or different data field (such as data field 308D shown in FIG. 3B). At runtime, in simple data binding 311A, the options in form fields (form field 312A and form field 312C) are pre-populated with unique values in data field 308C and data field 308D respectively using two separate copies of data in data instance 302D. As an example, a simple data binding is to bind a dropdown form field such as form field 312A to a data field 308C “country name” in a data instance 308D of countries in the world. At runtime the dropdown is pre-populated with names of countries for the publisher to select a valid country.

In multi-field lookup binding a named group of data bindings that depend on each other is created. In some embodiments, to setup multi-field lookup binding 311B, first multi-field lookup data 322 is created by selecting a data template 301D and giving it a name such as ‘Multi-Field Lookup1’ in this example to represent a group of bindings. Then all the key fields in data template 301D, for example data fields 308C and data field 308D (assuming these are the only two key fields in this data template) are bound to form fields—form field 312A and form field 312C respectively in this example. In some embodiments, some key fields assigned a constant value instead of binding to a form field. At run time, the options in form field 312A are first pre-populated with all unique values in data field 308C of data instance 302D. After a user selects a value in form field 312A, form field 312C is populated with data field 308D values, taken only from the records that match the selected value in form field 312A with data field 308C of the record. Thus, the multi-field field binding 311B makes web form interactive by linking the values in various form fields 312. As an example shown in FIG. 12, the form fields 1201, 1202 and 1203 are data bound using multi-field lookup binding 311B. First, the form field 1201 is pre-populated with unique values from data field “Menu”. When a user selects a menu from available menus, the dropdown list of form field 1202 is populated with the item names from the records that match the selected menu name. This way when a user selects “Lunch” in the form field 1201, form field 1202 is populated with only the lunch menu items. After the user selects an item in form field 1202, the form field 1203 is populated with the available spice levels for the item selected in form field 1202.

In some embodiments, for publication templates 303 that are not of type web form, for example publication template 303B of type text, only message properties 305B can be data bound since the message body 305A for such publication templates doesn't contain form fields.

In some embodiments, using simple data binding 311A, a form field in form fields 312 can also be bound to one of the following, instead of binding to one of data fields 308:
a) Context Info—Context information such as publisher's name, publisher's connections and the like.
b) Multi-field lookup data field—A field from a data template that is setup as a multi-field lookup 311B. As an example, in FIG. 12 form field 1204 is bound to multi-field lookup data field, “price”. After a user selects values in the form fields bound to the key fields of multi-field lookup, namely form field 1201 “Menu”, form field 1202 “Item”, and form field 1203 “SpiceLevel”, the field price is automatically populated with the price of the item. This is possible since selecting all key fields gives a unique menu item record.

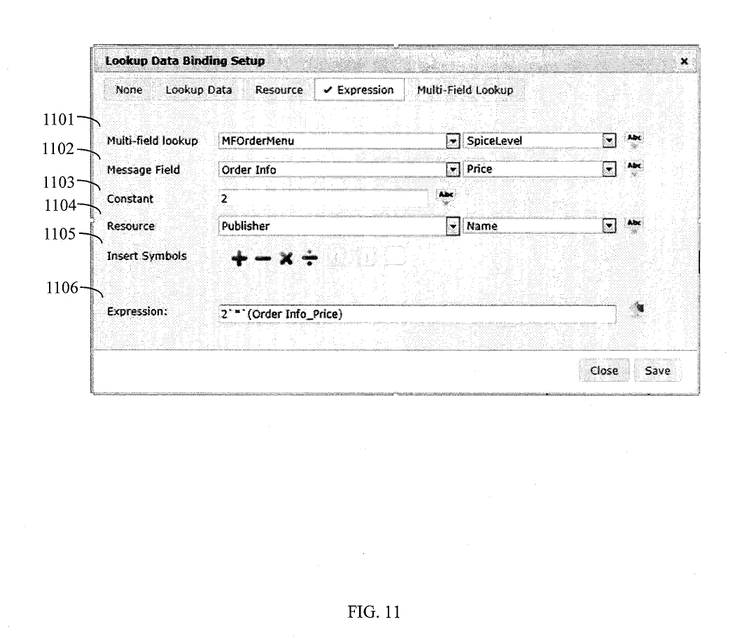

As used herein, an “expression” evaluates to a string or number. FIG. 11 shows a screenshot of an expression 1106 for simple data binding that is built by combining mathematical operators 1105 and values. In some embodiments, mathematical operators and values are selected from the group consisting of: a constant 1103 (number or string), a multi-field lookup field 1101 (non-key field), value in another form field 1102 in the same web form (Message Field in screenshot 4), a resource 1104, which is the context info described in item ‘a’ above, and the like and combinations thereof. In some embodiments, when a publication with a form field bound to an expression 1106 is executed by application execution engine 100D, expression 1106 is evaluated as follows: substitute the values, perform mathematical operations wherever mathematical operators are used, and finally perform string concatenation of all fields including results of mathematical operations performed. By way of example, in FIG. 12, form field 1205, “Total Cost”, is bound to an expression OnlineOrder_Quantity*OnlineOrder_Price. When the values in the form field “Price” or “Quantity” change, the expression is re-evaluated by application execution engine 100D to show correct value in “Total Cost”.

In some embodiments, creation of a publication such as publication 304A, comprises the steps of: (1) first selecting an appropriate publication template such as publication template 303A that defines the format of publication 304A, and (2) then for every data binding 311 in publication template 303A selected in step 1, uploading or selecting a data instance from data instances 302. In some embodiments, data filters 307A are selected to take a subset of data selected in step 2.

In some embodiments, publications 304 comprise one of the three publication types given below. Even though all the publications 304 are created the same way using same designer, the type of a publication such as publication 304A makes it work in a different context at run time as described below:
a) Broadcast Publication—Broadcast publication such as publication 304A is created to allow one publisher such as user 103A to publish information to plurality of users 103 who are subscribers, with no further communication required among the subscribers or the publisher. One example of this type of publication is flight status publication by an airline to the passengers. Using broadcast publication such as publication 304A, information can be published with an expiration date, in which case new subscribers to publication 304A continue to receive information until the expiration date of the information is reached. Information published using publication 304A can also be set to expire automatically when new information is published using the same publication i.e. publication 304A. As an example, flight status for a flight published using a broadcast publication can be set to expire when new status is published for the same flight. In some embodiments, the information published with no expiration is distributed only once to plurality of users 103 who are the subscribers at the time information is sent.
b) Application Publication—An application publication such as publication 304B is created for use in a specific application design. In some embodiments, publication 304B is used in application design 206A to design a plurality of information exchanges 321 in application design 206A. Application design 206A models a business process for automation that requires multiple information exchanges 321 between multiple users 103. Each of the information exchanges 321 in application design 206A uses one of the application publications such as publication 304B, created for application design 206A, for information exchange.
c) Library Publication—Library publication, for example publication 304C, is created to publish a library of information. In some embodiments, users 103 who subscribe to a publication of this type, get access to entire library which includes information published in past and any new information published while the subscription is active. The information published using a library publication such as publication 304C never expires but can be archived.

Application designs 206 are created to automate business processes that can be represented as series of information exchanges 321. On the Internet, most business processes including workflow applications on the Internet can be designed this way. In some embodiments, to build application design 206A, a set of roles 310 are defined in the application designer 201 by identifying various types of users in the business process being automated. An application publication such as publication 304B must be created for every information exchange in the process to be automated. After the required roles 310 and required publications 304 for the process are created, information exchanges 321 are designed using the application designer 201. Application design 206A includes a sequence of steps 322. In some embodiments, each step in steps 322 includes multiple information exchanges 321.

FIG. 3C portrays a diagram of application design 206A consistent with some embodiments of the present disclosure. In some embodiments, application design 206A is broken into multiple steps: step 322A, step 322B, step 322C, and so on. In some embodiments, each step contains one or more information exchanges. Every information exchange, for example information exchange 321A, contains a publisher role (role 310A), a subscriber role (role 310B), and a publication 304A. At runtime, the process is automated by executing the steps in a sequence. In some embodiments, only one or more of the subscriber roles 326 in a step such as role 310A and role 310C in step 322B can be setup as publisher roles 325 in the next step (step 322C), in some embodiments with new subscribers 310D. Thus, at runtime, when information is received by users 103 in a subscriber role 326 in a step, users in the same role act as publishers to publish information (as seen in 304D, 304E, 304F, 304G, and 304H) in response to the received information in next step. In some embodiments, the application design 206A is released for execution in application execution engine 100D after all information exchanges 321, such as information exchanges 321A, 321B, and 321C, in all the steps 322 of the business process being automated are completely defined.

Referring again to FIG. 3A, in some embodiments, runtime access to a broadcast publication such as publication 304A and a library publication such as publication 304C can be selectively granted to a plurality of users 103 by defining publication access control 300A (access to publish information) and subscription access control 300B (access to subscribe to information) on the publication. In some embodiments, runtime access to an application design such as application design 206A is selectively granted to plurality of users 103 by defining access control 300 on roles 310 in an application design 206A. In some embodiments, access control 300, publication access control 300A or subscription access control 300B are assigned one of the following possible values by the owner, a user who created the application design or the publication:
a. Owner (private)—only the owner of the application design or the publication is granted access.
b. Owner's Connections (connected)—only owner's connections are granted access.
c. Any user with permission (protected)—any user from users 103 is granted access after owner's permission.
d. Public—all users 103 are allowed access.

An exemplary embodiment of access control 300 setup is portrayed in FIG. 12. In this exemplary embodiment, publication 304A “online order” for a restaurant (user 103B). Since the online orders must be received only by the restaurant (user 103B), who is also the owner of publication 304A, subscription access control 300B to subscribe to publication 304A (to receive online orders) is set to owner only or “private”. Access control 300A to submit online order (publish) is set to “public” which means all registered users can submit online orders. If the restaurant chooses to allow only its connections to be able to submit online orders, publication access control 300A is set to “connected” (owner's connections) requiring the customers to first connect before submitting online orders.

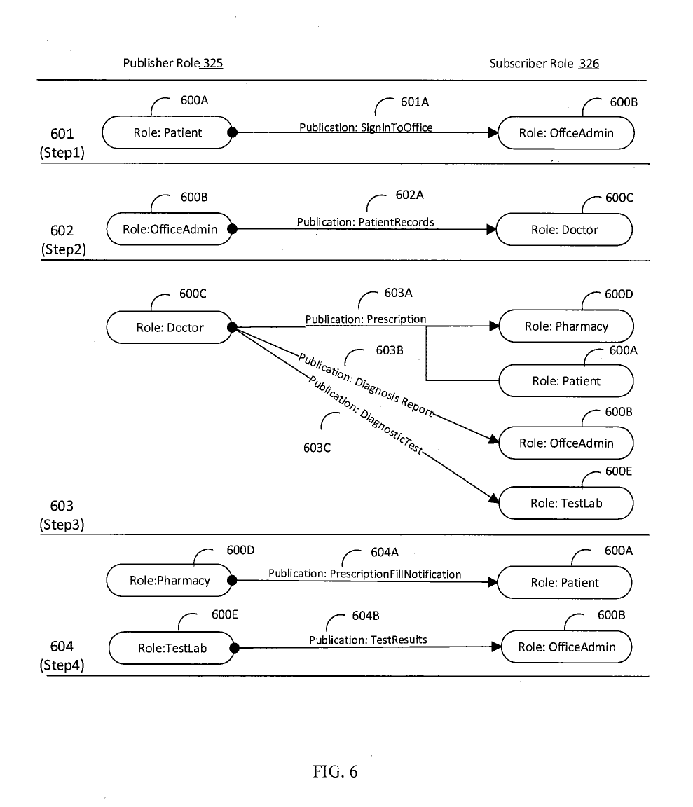

FIG. 6 is an example of an application design 206B consistent with some embodiments of the instant disclosure. In this embodiment, application design 206B automates a complex workflow process of a patient's visit to a doctor's office. Roles 310 for various types of users 103 in application design 206B are—Patient 600A, OfficeAdmin 600B, Doctor 600C, Pharmacy 600D, and TestLab 600E. In the rest of the description for this application design, for the sake of simplicity, a role name will be used to describe a user in the role even though there can be multiple similar users in each role. For example, “doctor 600C” will be used to describe one user who is a doctor in the role—Doctor 600C.

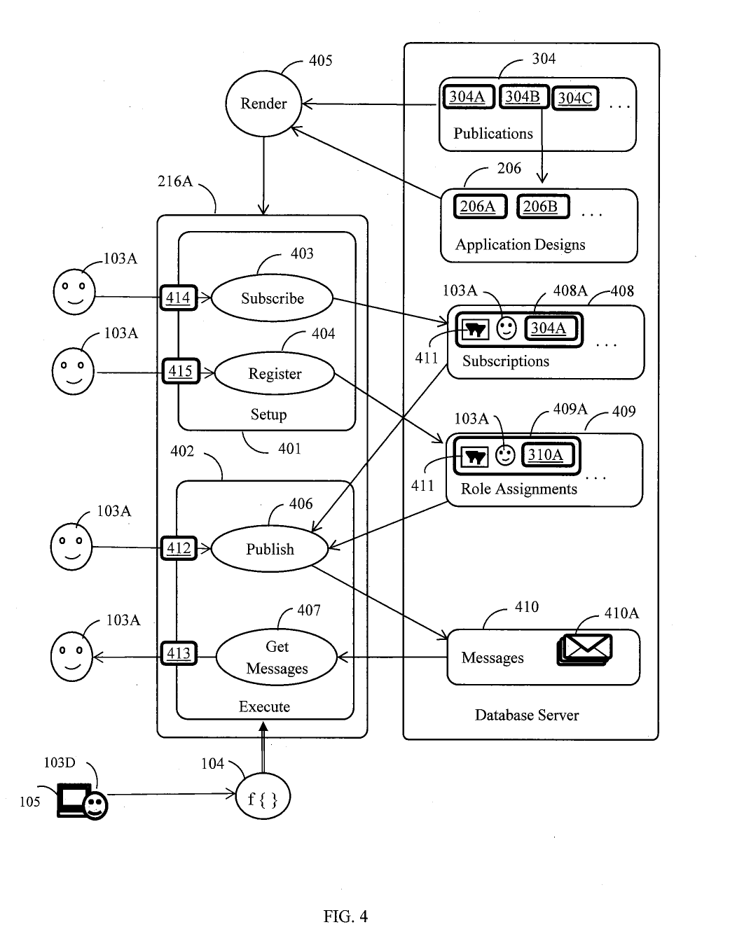

Users 103 register to application design 206B in plurality of the roles 310 described above. Each step in application design 206B has one or more publisher roles 325 and one or more subscriber roles 326 assigned to the step from roles 310 using application designer 201. Publisher roles 325 in a step must be from the list of subscriber roles 326 in the previous step except for the publisher roles 325 in the first step of application design 206B. At each step, when application design 206B is executed by application executor 202, users 103 in publisher roles 325 are provided with possible options of publications 304 to publish information. For example in step 3, doctor 600C can choose to not publish “Diagnostic Tests” (publication 603C) to Testlab 600E, if no tests are needed in a particular visit by patient 600A. At runtime, application 216B (described later in the section for application execution engine, FIG. 4) is initiated from application design 206B by patient 600A at the time of signing-in to office of a doctor 600C using publication 601A “SignInToOffice”. For embodiments with a fully automated workflow process, the patient is given access to a computer, setup for patient check-in at doctor's office. In some embodiments, the workflow design can be slightly modified to eliminate step 1, if the patient is not given access to a computer at doctor's office and an office admin 600B performs the sign-in for patient 600A. Acting on the sign-in message (information) received from patient 600A, the office admin 600B sends patient records to doctor 600C in step 2 using publication 602A “PatientRecords”. In step 3, doctor 600C gets an option to publish information using zero or more of the multiple available publications, such as publication 603A (Prescription), publication 603B (Diagnosis Report), and publication 603C (Diagnostic Tests). When publishing information using a publication, for example publication 603A, doctor 600C gets an option to select the recipients from list users 103 in role 600D, the subscriber role 326 for publication 603A in step 3 instead of publishing it to all users (pharmacies) in role 600D. Thus doctor 600C can send (publish) the prescription to a pharmacy preferred by patient 600A. The process continues (such as to step 4 and publications 604A (PrescriptionFillNotification) and 604B (TestResults) until the workflow is complete. This example shows implementation of a complex workflow application designed using reusable application building blocks 205, such as publications 304, in application designer 201 with no software programming required.

### Website Designs:

Referring again to FIG. 3A, users 103 use website designer 203 to assemble custom website designs 207 using, in some embodiments, publications 304, data views 306, HTML content 309, and the like from application building blocks 205. In some embodiments, application designs 206 can also be included in website designs 207.

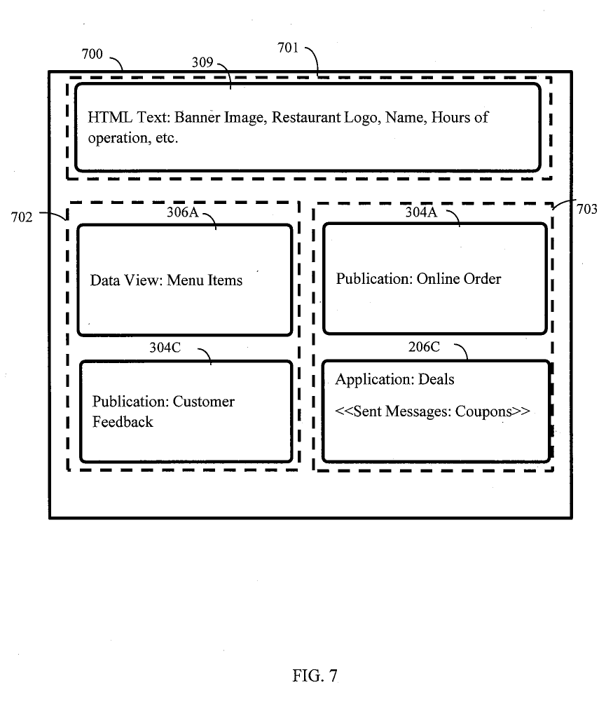

An exemplary embodiment of a website design 207A is shown in FIG. 7. Website design 207A is created by user 103B (a restaurant) using website designer 203. Website design 207A is created by first selecting a layout from available layouts offered by system 100 such as layout 700 in this example. In some embodiments, a layout such as layout 700 contains multiple zones. For example, layout 700 has three zones: zone 701 at the top, zone 702 on left below the top zone 701, and zone 703 on right below the top zone 701. In some embodiments, user 103B creates website design 207A by adding HTML content 309 that may include, but is not limited to, the restaurant's logo, banner image and other information. In FIG. 7, this content is added to top zone 701. To zone 702, in this example, user 103B adds data view 306A to show menu item name, item picture and price from data instance 302A that has restaurant's menu data. To zone 702, user 103B also adds publication 304C to display a feedback form to the customers, plurality of users 103, who want to submit feedback to restaurant 103B. Zone 703 contains publication 304A to present an online order form for takeout orders to customers (plurality of users 103). Also added to zone 703 is application design 206C to show to the website visitors, plurality of users 103, unexpired coupons published using an application rendered by application design 206C. Thus, user 103B designs of a functional website that automates business functions of a restaurant in an interactive website designer 203 without software programming.

Reusability and sharing of application building blocks 205 on website designs 207 and application designs 206 not only improves consistency and availability of business functions and business data for business automation, it also provides the end users a seamless and simple user interface for multiple applications with no learning curve with each application or website separately. The ability for users to connect for the purpose of designing, sharing, and executing business functions on applications and websites setup on system 100 eliminates the need for maintaining separate user databases and user registration systems for each application or website.

### Application Execution Engine:

FIG. 4 shows a diagram consistent with some embodiments of the present disclosure of execution of applications 216 by application executor 202. In some embodiments, an application such as application 216A is executed using one of the following: (1) a broadcast publication such as publication 304A, (2) a library publication such as publication 304C, or (3) an application design such as application design 206A. In some embodiments, application executor 202 first renders (designated by operation 405) application 216A to provide a user interface to the users 103 for execution of application 216A. In some embodiments, two types of operations are provided to users 103 on application 216A: (1) setup operations 401 that need to be completed by a user such as user 103A first, and (2) execute operations 402 that are performed on application 216 after setup operations are completed.

In some embodiments, a setup operation (a subscription operation (designated as 403)), is performed by user 103A to create one or more of subscriptions 408 for each of the publications 304 that are of interest to user 103A. In some embodiments, user 103A first searches for a publication of user's choice such as publication 304A and then subscribes (designated as operation 403) to it by using a subscription form 414 rendered by application executor 202. When creating a subscription such as subscription 408A, user 103A can choose to setup filters 411 in the subscription form 414 to receive only the messages 410 (published information) that match filters 411. Filters 411 are created as conditions on the message properties 305B of publication template 303A used to create publication 304A. As an example, filters 411 created to receive messages 410 from a publication “Flight Status” can be setup as “flight number is equal to 101” and “departure date is equal to 31 Dec. 2013”.

In some embodiments, user 103A performs a setup operation (a registration operation (designated as 404)) for each of the application designs 206 that is of interest to user 103A using application registration form 415 rendered (designated by operation 405) by application executor 202. Registration operation 404 registers the user to an application design such as application design 206A, thus adding the user to plurality of roles 310 that the user chooses in application design 206A, creating multiple role assignments 409. If a role used in a role assignment 409A is of type subscriber role 326 in application design 206A, filters 411 can also be created by user 103A in the role assignment 409A at the time of registration.

In some embodiments, after setup operations 401 are completed by a user for an application 216A, application 216A can be executed by performing execute operations 402. First, based on the selection by user 103A, application executor 202 renders (designated as 405) application 216A from at least one of the following: (1) an application design such as application design 206A, (2) broadcast publication such as publication 304A, and (3) a library publication such as publication 304C, and the like. In some embodiments, user 103A then performs two primary execute operations 402 on application 216A: (1) operation publish (designated as 406) and (2) operation “get messages” (designated as 407). In some embodiments, application 216A is rendered in a plurality of sections for each publication, such as a web form 412 rendered using a publication and a message list 413 of messages 410 received or sent using application 216A.

In some embodiments, user 103A publishes (designated as 406) information by entering it into web form 412 in application 216A rendered from a broadcast publication such as publication 304A or a library publication such as publication 304C, if access control 300A defined for the publication allows user 103A to publish (designated as 406).

In some embodiments, if an application such as application 216A is rendered from an application design 206A, user 103A publishes information by entering it into the web form 412 in at least the following two cases:
a) User 103A is registered in a role such as role 310A that is publication role 325 in first step 322A of application design 206A. Application executor 202 starts a new instance of application 216A in this case by rendering (designated as 405) publication 304B as web form 412.
b) When user 103A receives a message, for example message 410A, from an application publication such as publication 304B for role 310B (a subscriber role 326) that is also a publisher role 325 in the next step of the application, user 103A gets an option to respond to the received message 410A. Application executor 202 gives user 103A option to publish using plurality of publications 304 that are defined in the next step as publications for role 310B.

In some embodiments, when a publisher such as user 103A publishes information, it can be published to all subscribers or only to the subscribers selected by user 103A. For broadcast publications such as publication 304A, the information can also be published to plurality of users 103 who don't subscribe to publication 304A but allow unsolicited messages from user 103A. Application executor 202 saves published information to database server 209 as messages 410.

In some embodiments, operation “get messages” (designated by 407) is performed by a user such as user 103A to retrieve message list 413 for each publication. Message list 413 contains messages 410 that are sent or received by user 103A using a publication, for example publication 304A. In some embodiments, for an application design such as application design 206A used by user 103A, message list 413 is retrieved for each application publication for which user 103A is either a subscriber or a publisher based on user's roles 310 in application design 206A. In some embodiments, message list 413 is displayed to user 103A on system website 102.

In some embodiments, execute operations 402, publish 406, and get messages 407 for application 216A is to make programming calls to API 104 from a client application running on computer 105 of user 103D or to submit files containing the information to be published through API 104. Submitting a file is a suitable method for bulk submission of messages to be published. In some embodiments, the API 104 performs the same operations, namely publish (designated by 406) and get messages (designated by 407), except that the rendering of applications 216 on system website 102 is not needed.

Referring again to FIG. 5, several examples of different kinds of applications 216 are shown. In application 501, bank 501A uses broadcast publication 501B of type “file” to publish monthly statements to its customers 501C, wherein a filename contains a user identifier to deliver the file to the right user. In application 502, airline 502A uses broadcast publication 502B of type web form (structured data) to publish flight statuses to its passengers 502C. In application 503 that automates airline reservation process, first a passenger 503A submits a request for online booking using application publication 503B to airline 503C. The airline 503C, in response to the request for online booking 503B, sends order confirmation using application publication 503D to passenger 503A. Passenger 503A may choose to send order cancellation to airline 503C using application publication 503E. Finally airline 503C sends cancellation confirmation using application publication 503F. In application 505, weather department 505A uses broadcast publication 505B to publish local weather to users 505C who subscribed to publication 505B to get weather information.

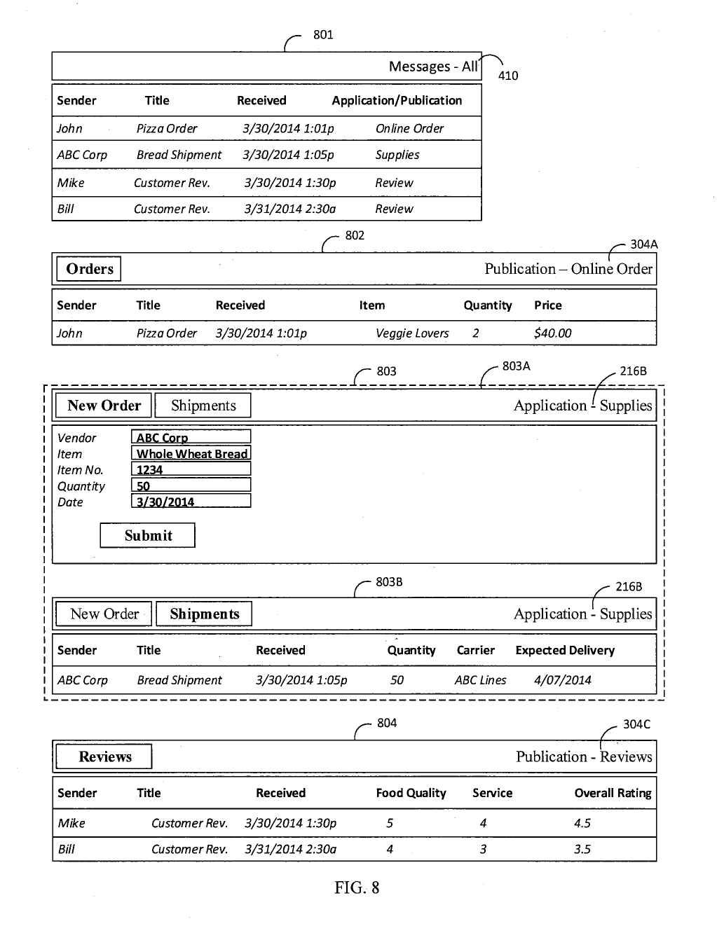

In some embodiments, various applications 216 are presented to a user such as user 103B on system website 102 by application executor 202 as webpages. In some embodiments, each application rendered separately with uniform user interface and functionalities. An exemplary embodiment of four different webpages is shown in FIG. 8, which portrays webpages 801, 802, 803 and 804. A webpage, for example webpage 803, provides an interface to publish or receive messages for an application such as application 216A and contains one or more sections. Webpage 801 is a common webpage for all applications 216 that user 103B is registered to. It shows all the messages 410 sent or received by user 103B using any of the applications 216. Webpage 802 shows the user interface for a broadcast publication 304A that user 103B subscribes to. It shows the messages 410 received by user 103B only for publication 304A, which are online orders placed by customers of user 103B (a restaurant). Webpage 803 shows a user interface created dynamically using application design 206B (as an example) that allows user 103B to place and track orders for restaurant supplies from various vendors. In this example, user 103B is registered to role “restaurant” in the application 206B, which is a publisher role 325 for publication “order” and a subscriber role 326 for publication “shipment”. The user interface for application 216B shows to user 103B, two separate sections: (1) section 803A named “new order” (created for publisher role to publication “order”) containing a web form created from publication 304A that can be used by user 103B to place a new order for supplies, and (2) section 803B named “shipments” (created for subscriber role to publication “shipment”) that shows order status messages received from the vendors for publication “shipment”. Webpage 804 shows a plurality of messages 410 in a table received for library publication 304C, namely reviews that contain customer reviews for user 103B (the restaurant).

As described in examples above, for each publication that user 103B is registered to publish information, in some embodiments application executor 202 renders a section containing a web form to publish information. After user 103B publishes one or more of messages 410, another section of sent messages is added to the webpage. For each publication that user 103B subscribes to, application executor 202 renders a section containing the messages 410 received by user 103B. When user 103B is registered to many roles 310 in an application such as application 206B, large number of sections may be needed on the webpage for application 206B.

Referring again to FIG. 2, an important part of application execution engine 100D is website host 204. In some embodiments, website host 204 assembles a functional website such as 217A by rendering components in each zone of a website design such as website design 207A in website layout 700 from FIG. 7. The publications 304 and application designs 206, added to the website layout 700, are rendered by website host 215 by calling application executor 202. In some embodiments, websites 217 generated by website host 215 can be displayed on system website 102. In some embodiments, websites 217 are hosted directly under user's own domain name, giving the users 103 an ability to have their own URLs (known in art as universal resource locators) for their websites.

### User Connection Manager:

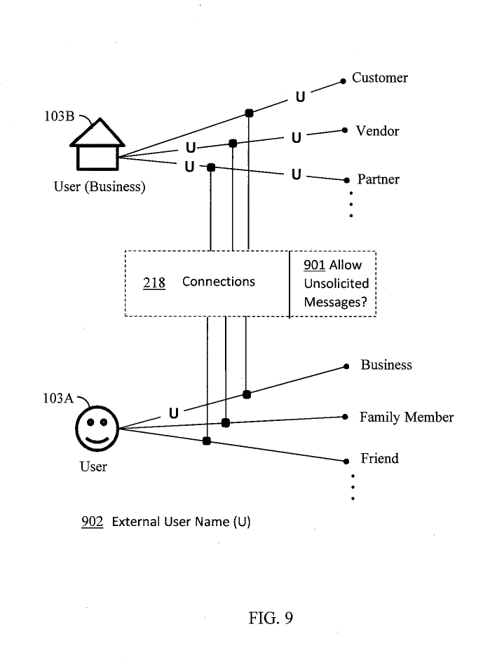

FIG. 9 portrays details of user connection manager 100E consistent with some embodiments of the present disclosure. In some embodiments, users such as user 103A and user 103B connect with other users on system 100 to exchange information or to participate in a business process automated on system 100. A connection request is initiated by a user such as user 103A; a connection is established after it is accepted by the other user for example user 103B. In some embodiments, while connecting with user 103B (a business), additional information such as external user name 902, can be set up. If both sides of a connection are businesses, external user name 902 can be setup on both sides of the connection (as designated by letter U in the diagram). External user name 902 is user name in an external system such as a website maintained and supported by a business user such as user 103B outside of system 100. In some embodiments, setup of external user name 902 requires one time authentication (login using external user name and password) on the external system and verification back to system 100 using API 104, which must be setup in advance on system 100 by user 103B who supports the external system. An example of this is a customer connecting to a bank and specifying customer's username on the bank's website as external user name 902. One time successful login to the bank's website verifies customer's identity and confirms customer's connection to the bank on system 100 with an external user name 902. A successful login to bank's website can be used to automatically accept connection request for the bank when a customer tries to connect to the bank. This eliminates need for a bank to manually accept large number of connection requests by the customers. Additionally, the bank can easily publish information such as bank statements, tax documents, and the like to connected customers by setting up external user name 902 as one of the properties in publications 304 that publish the documents.

In some embodiments, a user 103A at the time of connecting to user 103B can choose to “allow unsolicited messages” 901 from user 103B. This allows user's user 103B to send messages to the user 103A without any subscriptions by user 103A.

As will be apparent to one of ordinary skill in the art from a reading of this disclosure, further embodiments of the present invention can be presented in forms other than those specifically disclosed above. The particular embodiments described above are, therefore, to be considered as illustrative and not restrictive. Those skilled in the art will recognize, or be able to ascertain, using no more than routine experimentation, numerous equivalents to the specific embodiments described herein. Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways within the scope and spirit of the invention. The scope of the invention is as set forth in the appended claims and equivalents thereof, rather than being limited to the examples contained in the foregoing description.

What is claimed is:

1. A web-based, electronic system for providing business automation information exchange services including:
an application design engine for assembling business automation designs from application building blocks, application designs, and website designs;
an application execution engine, said application execution engine including an application executor for executing said application designs;
an user connection manager for connecting a first user and one or more users;
wherein an application designed by said application design engine facilitates at least one publication exchange between said first user and said one or more users upon execution of said business automation designs;
wherein said application design engine, application execution engine, and user connection manager are hosted on a web server accessible by said one or more users; and
wherein said business automation designs are created without software programming.

2. The web-based, electronic system according to claim 1, wherein said business automation information exchange services are accessed through an interface selected from the group consisting of: a web browser, an application programming interface, and combinations thereof.

3. The web-based, electronic system according to claim 2, wherein said interface is an application programming interface, and wherein said system further comprises a business automation client.

4. The web-based, electronic system according to claim 1, said application execution engine including a website host for rendering websites.

5. The web-based, electronic system according to claim 1, wherein publications are rendered by said application execution engine, wherein said publications are created using a publication template selected from the group consisting of: a web form, text, XML, a file, media album, and combinations thereof.

6. The web-based, electronic system according to claim 5, wherein said publications are selected from the group consisting of: a broadcast publication, an application publication, and a library publication.

7. The web-based, electronic system according to claim 1, wherein said application building blocks are selected from the group consisting of: data templates defining business data formats, data views, data filters, data instances, said publication templates defining the format of said publications to be exchanged, said publications, subscriptions to subscribe to and receive said publications, HTML content, and combinations thereof.

8. The web-based, electronic system according to claim 7, wherein said data fields are bound to form fields in said publication to facilitate entry of data instances into said publication.

9. The web-based, electronic system according to claim 1, wherein said publication is an e-commerce web form.

10. A web-based, electronic method for providing business automation information exchange services including:
providing an application design engine;
providing an application execution engine;
providing a user connection manager for managing connections between at least a first user and at least a second user;
assembling a business automation design using said application design engine;
subscribing said at least a second user to a publication;
executing said business automation design using said application execution engine to render a publication and send said publication to said at least a second user; and
wherein said business automation design is created without software programming.

11. The web-based, electronic method for providing business automation information exchange services according to claim 10, further comprising the step of creating a publication which includes the steps of:
selecting a publication template including at least one form field;
binding a data field to said at least one form field; and
uploading a data instance to said data field.

12. The web-based, electronic method for providing business automation information exchange services according to claim 10, wherein the step of assembling a business automation design using said application design engine includes the steps of:
defining at least a first set of roles for said at least a first and second users; and
wherein said rendering of said publication and sending of said publication is based on said at least a first set of roles defined for said users.

13. The web-based, electronic method for providing business automation information exchange services according to claim 12, further comprising the step of defining access control for said at least a first user and said at least a second user.

14. The web-based, electronic method for providing business automation information exchange services according to claim 10, wherein said publication is selected from the group consisting of: a broadcast publication, an application publication, and a library publication.

15. The web-based, electronic method for providing business automation information exchange services according to claim 10, wherein said business automation designs are stored for access by users of the system.

16. The web-based, electronic method for providing business automation information exchange services according to claim 9, further comprising the step of registering said at least a first user and said at least a second user for said at least a first set of roles associated with said business application design.
